(19) United States
(12) Patent Application Publication
(10) Pub. No.: US 2006/0139960 A1
(43) Pub. Date: Jun. 29, 2006

(54) Surface light source device and display apparatus using the same

(75) Inventors: Seiji Sakai, Tokyo (JP); Toshiyuki Yoneda, Tokyo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 11/291,979

(22) Filed: Dec. 2, 2005

(30) Foreign Application Priority Data
Dec. 27, 2004 (JP) 2004-375997
Apr. 1, 2005 (JP) 2005-106123

(51) Int. Cl. F21V 7/04

(52) U.S. Cl. 362/623

(57) ABSTRACT

A surface light source device includes a housing having an opening portion provided in a top surface thereof, a reflection sheet disposed on a bottom surface of the housing, a light guide plate disposed on the reflection sheet on a side of the opening, and a light source disposed on at least one of side surfaces of the housing. The reflection sheet has a first reflection region on a side opposite to the light source, and a reflectance of the first reflection region at shorter wavelengths in a wavelength region of visible light outputted from the light source is higher than a reflectance at longer wavelengths in the wavelength region of the visible light.

### BACKGROUND OF THE INVENTION

1. Field of the Invention

The present invention relates to a surface light source device, in which a reflection sheet is colored, and to a display apparatus using this device.

2. Description of the Related Art

A related surface light source device (see, for example, JP-A-8-240720 (page 4, left column, line 39 to right column, line 27, and FIG. 1)) has a color printed-dot portion that is provided on the top surface of a reflection sheet placed in the vicinity of a light entrance end surface of a light guide plate. Thus, excessive light, which may cause leakage of light, is absorbed by the color printed-dot portion. Consequently, leakage of light, which impair display quality, can be prevented from occurring at an end portion of a screen in the vicinity of a fluorescent tube 36.

Another related surface light source device is constituted by a light distributing means, a light emitting diode, a reflecting means provided to face the light distributing means, a hollow region formed between the light distributing means and the reflecting means, and a reflector (see, for instance, JP-A-2002-258764 (page 4, left column, line 3 to page 5, left column, line 43, and FIG. 1)).

In the related surface light source device disclosed in JP-A-8-240720, short wavelength components of visible light outputted from the light source are liable to be absorbed or scattered by the light guide plate, the reflection sheet, and the color printed-dot portion. Thus, the related surface light source device disclosed in JP-A-8-240720 has a problem in that as the distance of a part in the display surface of a liquid crystal apparatus from a light source increases, color irregularity is more likely to occur in such a part in the display surface so that the color of such a part in the display surface changes to red.

Further, in the related surface light source device disclosed in JP-A-2002-258764, light emitted from the light emitting diode provided in the vicinity of an end of the light distributing means is uniformly reflected by the reflecting means toward the light distributing means. Thus, luminance is uneven in this related device, so that the luminance in the vicinity of the light emitting diode is high, and that as the distance of a place from the light emitting diode increases, the luminance decreases. This unevenness of the luminance of illuminating light in the surface light source device results in problems that luminance unevenness and color irregularity occur in a displayed image, and that the quality of the image is degraded.

### SUMMARY OF THE INVENTION

The invention provides a surface light source device that has a reflection sheet and that is enabled to prevent occurrence of color irregularity and luminance unevenness. The invention also provides a liquid crystal display apparatus that employs this surface light source device and that is enabled to obtain excellent display characteristics.

According to a surface light source device according to the invention, a reflection sheet has a reflection region, which is provided at a side opposite to the light source and is adapted so that the a reflectance at shorter wavelengths of the wavelength region of visible light outputted from the light source is higher than the reflectance at longer wavelengths of the wavelength region of the visible light.

According to the invention, the reflection sheet has the reflection region, which is provided at the side opposite to the light source and is adapted so that the reflectance at shorter wavelengths of the wavelength region of visible light outputted from the light source is higher than the reflectance at longer wavelengths of the wavelength region of the visible light. Thus, the color irregularity, which is more likely to occur at a part in the display surface and as the distance of this part from the light source increases, and which causes the color of such apart to change to red, is cancelled. Thus, at a part provided at the side opposite to the light source in the display surface of the display apparatus, the color irregularity can be suppressed.

### BRIEF DESCRIPTION OF THE DRAWINGS

FIG. 1 is a plan view illustrating an outline of the configuration of a surface light source device according to a first embodiment of the invention;

FIG. 2 is a partial cross-sectional view of the surface light source device, which is taken on line II-II shown in FIG. 1;

FIG. 3 is a view illustrating an example of point-like light sources using light emitting diodes (LEDs);

FIGS. 4A and 4B are luminosity distribution graphs illustrating the light distribution of the light emitting diode; FIG. 4A is a luminosity distribution graph illustrating the light distribution of a red light emitting diode; and FIG. 4B is a luminosity distribution graph illustrating the light distribution of a blue/green light emitting diode;

FIGS. 5A to 5C are plan views illustrating color patterns of a reflection sheet; FIG. 5A is a plan view of a reflection sheet in a case where a light source is disposed only in the vicinity of one side surface of a housing; FIG. 5B is a plan view of the reflection sheet in a case where the light source is disposed in the vicinity of each of two opposed side surfaces of the housing; and FIG. 5C is a plan view of the reflection sheet, which illustrates another example of the color pattern;

FIG. 6 is a plan view illustrating an outline of the configuration of a surface light source device according to a second embodiment of the invention;

FIG. 7 is a partial cross-sectional view of the surface light source device, which is taken on line VII-VII shown in FIG. 6;

FIG. 8 is a plan view illustrating an outline of the configuration of a surface light source device according to a third embodiment of the invention;

FIG. 9 is a partial cross-sectional view of the surface light source device, which is taken on line IX-IX shown in FIG. 8;

FIGS. 10A and 10B are plan views illustrating color patterns of a reflection sheet; FIG. 10A is a plan view of a reflection sheet, which illustrates an example of the color pattern in a case where a light source is disposed only in the vicinity of one side surface of a housing; and FIG. 10B is a plan view of the reflection sheet, which illustrates one example of the color pattern in a case where the light source is disposed in the vicinity of each of two opposed side surfaces of the housing;

FIGS. 11A to 11C are plan views illustrating color patterns of a reflection sheet; FIG. 11A is a plan view of a reflection sheet, which shows another example of the color pattern in a case where a light source is disposed only in the vicinity of one side surface of a housing; FIG. 11B is a plan view of the reflection sheet, which shows another example of the color pattern in a case where the light source is disposed in the vicinity of each of two opposed side surfaces of the housing; and FIG. 11C is a plan view of the reflection sheet, which shows still another example of the color pattern;

FIG. 12 is a plan view illustrating an outline of the configuration of a surface light source device according to a fourth embodiment of the invention;

FIG. 13 is a partial cross-sectional view of the surface light source device, which is taken on line XIII-XIII shown in FIG. 12;

FIG. 14 is a plan view of the reflection sheet, which shows an example of the color pattern;

FIG. 15 is a plan view illustrating an outline of the configuration of a surface light source device according to a fifth embodiment of the invention;

FIG. 16 is a partial cross-sectional view of the surface light source device, which is taken on line XVI-XVI shown in FIG. 15;

FIG. 17 is a plan view of the reflection sheet, which shows an example of the color pattern;

FIG. 18 is a plan view illustrating an outline of the configuration of a surface light source device according to a sixth embodiment of the invention;

FIG. 19 is a partial cross-sectional view of the surface light source device, which is taken on line XIX-XIX shown in FIG. 18; and

FIG. 20 is a plan view of a reflection sheet, which shows an example of a coloring pattern.

### DETAILED DESCRIPTION OF THE INVENTION

### First Embodiment

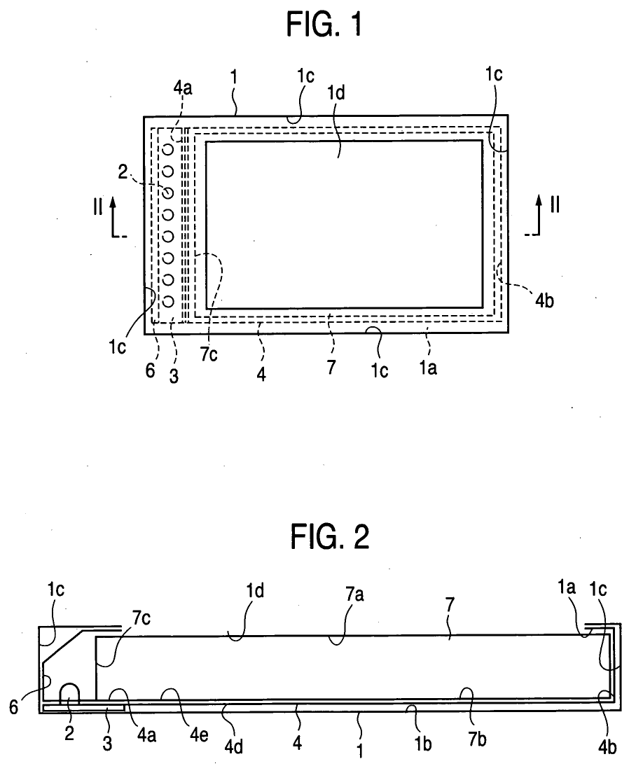

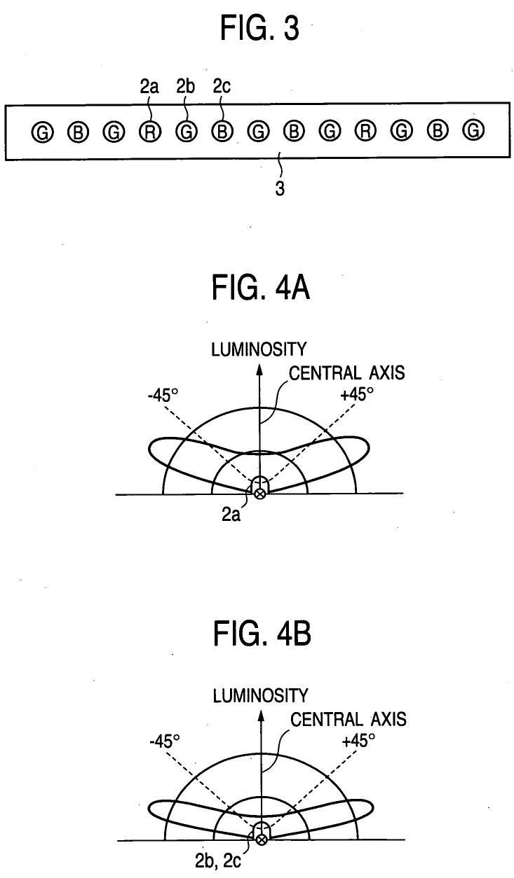

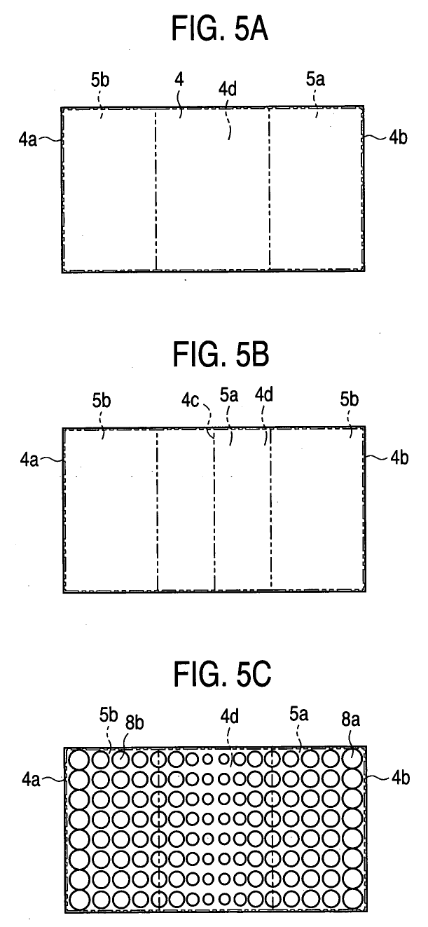

FIG. 1 is a plan view illustrating an outline of the configuration of a surface light source device according to a first embodiment of the invention. FIG. 2 is a partial cross-sectional view of the surface light source device, which is taken on line II-II shown in FIG. 1. FIG. 3 is a view illustrating an example of point-like light sources using light emitting diodes (LEDs). FIGS. 4A and 4B are luminosity distribution graphs illustrating the light distribution of the light emitting diode. FIG. 4A is a luminosity distribution graph illustrating the light distribution of a red light emitting diode. FIG. 4B is a luminosity distribution graph illustrating the light distribution of a blue/green light emitting diode. FIGS. 5A to 5C are plan views illustrating color patterns of a reflection sheet. FIG. 5A is a plan view of a reflection sheet in a case where a light source is disposed only in the vicinity of one side surface of a housing. FIG. 5B is a plan view of the reflection sheet in a case where the light source is disposed in the vicinity of each of two opposed side surfaces of the housing. FIG. 5C is a plan view of the reflection sheet, which illustrates another example of the color pattern. As shown in FIGS. 1 to 5C, a housing 1 of the surface light source device includes a top surface 1a, a bottom surface 1b, and 4 side surfaces 1c. The housing 1 has an opening portion 1d formed in the top surface 1a.

Examples of the light source are linear light sources, such as a cold cathode tube, and point-like light sources, such as a light emitting diode (hereunder referred to as LED) and a laser diode (hereunder referred to as LD). The LED includes a semiconductor light emitting diode, which emits blue monochromatic light, and a white LED, which includes a fluorescent material that absorbs blue light emitted from the semiconductor light emitting device and emits yellow light. This first embodiment employs LEDs, which are point-like light sources 2 that are a fist point-like light source 2a that emits red light (R), a second point-like light source 2b that emits green light (G), and a third point-like light source 2c that emits blue light (B).

Incidentally, an AlInGaP semiconductor light emitting device is used as the red LED. InGaN semiconductor light emitting diodes are used as the blue LED and the green LED. The red LED is a semiconductor light emitting diode that differs from those used as the blue LED and the green LED. Thus, as shown in FIGS. 4A and 4B, the red LED differs from each of the blue LED and the green LED in the luminosity distribution.

The LED, which emits red, green, or blue monochromatic light rays, is high in luminous efficiency, as compared with a LED that emits white light. The red, green, and blue transmission characteristics of color filters used in a liquid crystal display apparatuses are combined with the emission spectrum characteristics of the LEDs, so that a display apparatus having high color-reproducibility is obtained. Thus, such LEDs a repreferable. Also, the hue and the luminance of light emitted from the surface light source device can easily be changed by controlling the LEDs respectively corresponding to colors independently. Thus, the LEDs are preferable.

Plural point-like light sources 2a rearranged and mounted at even intervals on a rectangular point-like light source substrate 3 along the longitudinal direction of the substrate 3. Thus, the positioning of the point-like light sources 2 onto the substrate 3 is performed. The point-like light source substrate 3 is disposed along at least one of side surfaces 1c of the housing 1. The plural point-like light sources 2 are disposed in rows along the side surface 1c of the housing 1. Further, the point-like light sources 2 are electrically connected to the point-like light source substrate 3 and supplies external electrical signals to the point-like light sources 2.

The number of the first point-like light sources 2a, the number of the second point-like light sources 2b, and the number of the first point-like light sources 2c provided on the point-like light source substrate 3 are not necessarily equal to one another. It is advisable to optionally set the number of the first point-like light sources 2a, the number of the second point-like light sources 2b, and the number of the first point-like light sources 2c so that the chromaticity of light outputted therefrom, which is transmitted by liquid crystal display devices, can be optimized. For example, as shown in FIG. 3, the point-like light sources G, B, G, R, G, B, . . . can be disposed in this order repeatedly.

The housing 1 is set to prevent light as much as possible from leaking out therefrom. A reflection sheet 4 is provided along the top surface 1a, the bottom surface 1b, and the side surface 1c, which are inner surfaces of the housing 1, so that light is reflected on the inner surfaces and travels toward the opening portion 1d. The reflection sheet 4 is made of a material, which is obtained by mixing PP (polypropylene) or PET (polyethylene terephthalate) with barium sulfate or titanium oxide, a material obtained by forming fine air bubbles in a resin, a material obtained by depositing silver on a metal plate, or a material obtained by applying a coating compound, which includes titanium oxide, onto a metal plate.

The reflection sheet 4 has a first reflection region 5a, which is provided at the side opposite to the light source 2 and which is adapted so that the reflectance at shorter wavelengths of the wavelength regions (that is, a range of wavelengths from 380 nm to 430 nm, that of wavelengths from 430 nm to 490 nm, that of wavelengths from 490 nm to 550 nm, that of wavelengths from 550 nm to 590 nm, that of wavelengths from 590 nm to 640 nm, and that of wavelengths from 640 nm to 770 nm) respectively corresponding to colors (that is, violet, blue, green, yellow, orange, and red) of visible light (see, Chronological Scientific Tables, desktop version, page 27 (2003)) outputted from the light source is higher than the reflectance at longer wavelengths of the other wavelength regions of the visible light. Also, the reflection sheet has a second reflection region 5b, which is provided at the side of the light source and which is adapted so that the reflectance at shorter wavelengths of the wavelength regions of the visible light is lower than that at longer wavelengths of the wavelength regions of the visible light.

Incidentally, in a plane of the reflection sheet 4, which corresponds to the bottom surface 1b of the housing 1, a side located close to the light source is set to be a light source side. Conversely, a side located far from the light source is set to be a side at the side opposite to the light source.

Especially, in a case where the light source is disposed only in the vicinity of the one side surface 1c of the housing 1, a first side 4a located close to the light source is at the S light source side, while a second side 4b opposed to this first side 4a is at the side opposite to the light source, as shown in FIG. 5A.

In a case where the light source is disposed in the vicinity of each of the two opposed side surfaces 1c of the housing 1, the first side 4a and the second side 4b, which are located close to the light source, are at the light source side, while a central portion 4c located far from the light source and at an equal distance from the first side 4a and the second side 4b is at the side opposite to the light source, as shown in FIG. 5B.

In this first embodiment, the first reflection region 5a is a color pattern portion obtained by coloring the reflection sheet 4 in blue, and is adapted so that the reflectance of light of wavelengths in wavelength regions respectively corresponding to red and green is 50% and that the reflectance of light of wavelengths in a wavelength region corresponding to blue is 80%.

The second reflection region 5b is a color pattern portion obtained by coloring the reflection sheet 4 in orange or red, and is adapted so that the reflectance of light of wavelengths in a wavelength region corresponding to blue is 50%, that the reflectance of light of wavelengths in a wavelength region corresponding to green is 80%, and that the reflectance of light of a wavelengths in wavelength region corresponding to red is 90%.

A lamp reflector 6 surrounds the point-like light sources 2 except a part located at the side of a light guide plate 7 (to be described later). The lamp reflector 6 reflects light, which is outputted from the light sources, to the light guide plate 7. The lamp reflector 6 is formed of a metal plate, which has a reflection layer made of silver or aluminum, or formed of a material, such as a white resin sheet.

Incidentally, preferably, the reflectances of the reflection sheet 4 and the lamp reflector 6 are equal to and more than 90% so as to suppress reflection loss. Also, preferably, the reflectance is increased by coloring the inner surfaces of the housing 1 in white. Thus, the reflectability of the inner surfaces of the housing 1 is enhanced still more. Also, the reflection loss is reduced. Although the reflection sheet 4 and the lamp reflector 6 are constituted by different members, respectively, the number of members can be decreased by forming the reflection sheet 4 and the lamp reflector 6 integrally with each other through the use of the same member. Also, the assembling workability of the device can be enhanced.

Preferably, the housing 1 is formed to perform the functions of the reflection sheet 4 and the lamp reflector 6. Thus, the number of members of the device can be reduced. In this case, effects of the color pattern obtained by coloring the reflection sheet 4, which will be described later, can be obtained by providing the color pattern of the reflection sheet 4 on the bottom surface 1b of the housing 1.

The light guide plate 7, which propagates light outputted from the point-like light sources 2 to the opening portion 1d, is disposed in the housing 1 at the side of the opening portion 1d to be opposed to the reflection sheet 4. The light guide plate 7 is formed of a resin plate, such as polyethylene terephthalate (PET), polymethylmethacrylate (PMMA) or polycarbonate (PC), alternatively, a glass substrate. Such a resin plate or a glass substrate has a refractive index ranging from 1.4 to 1.6 and also has the function of transmitting light.

Plural optical sheets (not shown) is disposed on the light guide plate 7 so as to effectively utilize light. Liquid crystal display devices (not shown) are placed on the light guide plate 7 through the optical sheets.

Incidentally, the optical sheet is formed by causing diffusion sheets to sandwich a lens sheet. In a case where it is necessary to enhance the luminance, it is advisable to combine plural diffusion sheets with one another in consideration of a refracting angle of a prism formed on the surface thereof. In a case where it is necessary to enhance diffusivity, two or more diffusion sheets may be used. Also, depending upon the light distributing characteristics of the lens sheet, only one lens sheet may be used. Alternatively, the lens sheet may be unused. Alternatively, a combination of a protection sheet, a lens sheet, and/or a polarizing reflection sheet may be used. Alternatively, neither such optical sheets, nor the combination of the sheets can be used. Preferably, the use of such optical sheets or the combination of the sheets is optimized in view of the necessary luminance and the desired light distributing characteristics.

Examples of a display portion disposed on the top portion of the surface light source device are a liquid crystal display device to which the birefringence of a liquid crystal is applied, and a printed material obtained by printing characters and pictures on a transparent plate. In this embodiment, the liquid crystal display device is used as the display portion.

The liquid crystal display device includes a TFT array substrate, which is obtained by forming thin film transistors (hereunder referred to as TFT) serving as a coloring layer, a light shielding layer, and a switching device, electrodes, such as pixel electrodes, and wiring on an upper or lower substrate (not shown), a counter substrate, a spacer operative to hold these two substrates at a constant distance, a bonding material used to bond the two substrates together, a sealing material used to seal between the two substrates after liquid crystals are injected therebetween, an orientation film used to provide an initial orientation to the liquid crystals, and a polarization plate used to polarize light. However, existing liquid crystal display devices are used in this embodiment. Thus, the description of the liquid crystal display devices is omitted herein.

The liquid crystal display apparatus has a circuit board (not shown) used to drive the liquid crystal display devices and is configured by disposing the liquid crystal display devices on an upper portion of the surface light source device.

Next, an optical path, through which light emitted from the point-like light sources 2 is outputted from the top surface 7a of the light guide plate 7 and is inputted to the liquid crystal display device, is described hereinbelow.

The light emitted from the point-like light source 2 is directly incident on an incidence face 7C of the light guide plate 7 or is incident thereon after reflected by the lamp reflector 6.

The light having been incident on the light guide plate 7 is totally reflected iteratively at the boundary between the light guide plate 7 and an air layer, while propagates in the light guide plate 7. The light propagating in the light guide plate 7 is diffusion-reflected at a dot printing portion (not shown) provided on the bottom surface 7b of the light guide plate 7, which corresponds to the opening portion 1d of the housing 1, to thereby change the propagating direction of the light. Thus, the light can be incident on the top surface 7a of the light guide plate 7 at an incidence angle, which is less than a critical angle, with respect to the boundary between the light guide plate 7 and the air layer. Finally, the light is outputted from the opening portion 1d of the housing 1, which portion is not covered by the reflection sheet 4.

Incidentally, a part of light is outputted from surfaces other then the top surface 7a of the light guide plate 7. However, this part of light is reflected by the reflection sheet 4 provided on each of the bottom surface 1b, the top surface 1a, and the side surfaces 1c of the housing 1. Thus, the reflected light is incident again on the light guide plate 7, and thereafter, is outputted from the top surface 7a of the light guide plate 7.

Incidentally, the light guide plate, the reflection sheet, and the dot printing portion are liable to absorb or scatter shorter wavelength light. Thus, in the related surface light source device using the reflection sheet, during light propagates in the light guide plate 7, the rate of longer wavelength light increases. Consequently, in the light outputted from the top surface 7a of the light guide plate 7, the rate of the longer waveform components of the light, which are outputted from a portion at the light source side to a portion at the side opposite to the light source, increases. That is, red components of light increases. Thus, color irregularity occurs at the opening portion id of the housing 1.

However, in this first embodiment, the first reflection region 5a of the reflection sheet 5, which region is provided in the vicinity of the second side 4b at the side opposite to the light source, is colored with a complementary color that cancels change in hue of light, which is outputted from the light source, at the opening portion 1d of the housing 1. Thus, the color irregularity at the opening portion 1d of the housing 1 is suppressed.

Further, the light guide plate 7, the reflection sheet 4, and the dot printing portion are liable to absorb or scatter shorter wavelength light. Thus, in the related surface light source device using the reflection sheet, color irregularity occurs at a part of the opening portion 1d of the housing 1, which part is located at the light source side, by changing the color of the surface of the part to blue.

However, the second reflection region 5b of the reflection sheet 5, which region is provided in the vicinity of the first side 4a of the reflection sheet 4 at the light source side, is colored with a complementary color that cancels change in hue of light, which is outputted from the light source, at the opening portion 1d of the housing 1. Thus, the color irregularity at the opening portion 1d of the housing 1 is suppressed.

As shown in FIGS. 4A and 4B, the red LED, the blue LED, and the green LED differ from one another in the luminosity distribution. Thus, in the related surface light source device using the reflection sheet, color separation and color irregularity occur. Consequently, image quality is degraded.

However, in this first embodiment, the first reflection region 5a, which is disposed at the side opposite to the light source, and the second reflection region 5b, which is disposed at the light source side, are provided. Further, the first reflection region 5a and the second reflection region 5b are colored with complementary colors that cancel change in hue of light, which is outputted from the light source, at the opening portion 1d of the housing 1. Thus, the color irregularity is suppressed.

Incidentally, even when only one of the first reflection region 5a and the second reflection region 5b is formed in the reflection sheet 4, the effect of the formed reflection region can be obtained. Thus, this embodiment can effectively suppress the color irregularity, as compared with the related surface light source device. Itis preferable that the reflection sheet 4 has the first reflection region 5a and the second reflection region 5b, so that the color irregularity can be suppressed in an area extending from the light source side to the side opposite to the light source.

Light outputted from the opening portion 1d of the housing 1 is incident on the liquid crystal display device through the diffusion sheet, the protection sheet, and the lens sheet. The liquid crystal display device is adapted so that a liquid crystal layer is orientated in response to the on/off of a voltage by a switching device (not shown). Thus, the light having been incident on the liquid crystal device is modulated according to a video signal and shows red, green and blue.

Incidentally, in a case where LEDs, which respectively emit red (R), green (G), and blue (B) monochromatic color rays, are used as the light sources, emission spectra of each of these colors has a narrow half-value width. There are few emission spectra corresponding to each of the colors other than red (R), green (G) and blue (B). Thus, as compared with the case of using a cold-cathode ray tube as the light source, the device using such LEDs as the light source has a tendency that an amount of change in chromaticity in the case of absorbing shorter wavelength light increases. Consequently, color irregularity, which is not clearly visually recognized in the case of using the cold-cathode tube as the light source, can be easily and visually recognized in the case of employing the LEDs as the light sources. However, the color irregularity can be eliminated with high precision by using the reflection sheet 4 in this first embodiment.

Although the first reflection region 5a is formed in this first embodiment as a color pattern portion having a constant reflectance, the color irregularity can be more effectively cancelled, as compared with the case of using the color pattern portion adapted so that the reflectance of the first reflection region 5a is constant, by setting the first reflection region to be a color pattern portion (hereunder referred to as a gradation pattern portion) adapted so that the difference between the reflectance at the longer wavelengths and the reflectance at the shorter wavelengths at a part in this region increases as the distance of this part from the light source increases, that is, so that the reflectance at shorter wavelengths, which is higher than the reflectance at longer wavelengths in the vicinity of the light source, at a part in the first reflection region 5a is gradually changed and become equal to the reflectance at longer wavelengths as the distance of this part from the light source increases. The gradation pattern is preferable, because a change between the first reflection region and another region is obscured.

Further, although the second reflection region 5b is set to be a color pattern portion having a constant reflectance, the color irregularity can be more effectively cancelled, as compared with the case of using the color pattern portion adapted so that the reflectance of the first reflection region 5a is constant, by setting the first reflection region to be a gradation pattern portion adapted so that the difference between the reflectance at the longer wavelengths and the reflectance at the shorter wavelengths at a part in this region increases as the distance of this part from the light source increases, that is, so that the reflectance at shorter wavelength, which is lower than the reflectance at longer wavelengths in the vicinity of the light source, at a part in the second reflection region 5b is gradually changed and become equal to the reflectance at longer wavelengths as the distance of this part from the light source increases. The gradation pattern is preferable, because a change between the second reflection region and another region is obscured.

The color pattern portion may be formed by applying a dot pattern 8 on the reflection sheet according to a screen printing method. That is, the color pattern portion may be obtained by printing a micro-pattern on the reflection sheet 4 using black, gray, and chromatic ink. Preferably, the shapes, the sizes, the arrangement, and the densities of dots, the color of ink, and changes in these factors are optimized in view of the display quality at the opening portion 1d of the housing 1.

For example, as shown in FIG. 5C, a dot pattern 8a is enabled to increase the occupation ratio of a blue or blue green dot pattern to the reflection sheet 4 relatively with respect to the attenuation factor at shorter wavelengths of light so that the difference between the reflectance at longer wavelengths of light and the reflectance of shorter wavelength components thereof at a part in the reflection sheet increases as the distance of this part from the point-like light source 2 increases. This dot pattern 8a may be applied to the reflection sheet 4.

A dot pattern 8b is enabled to decrease the occupation ratio of an orange or red dot pattern to the reflection sheet 4 relatively with respect to the attenuation factor at shorter wavelengths of light so that the difference between the reflectance at longer wavelengths of light and the reflectance at shorter wavelengths thereof at apart in the reflection sheet decreases as the distance of this part from the point-like light source 2 increases. This dot pattern 8a may be applied to the reflection sheet 4.

A method of forming a color pattern portion on the reflection sheet is not limited to the screen printing method. A deposition method or a spray painting method may be employed, as long as a color pattern portion having similar effects.

Although a reflection region, which is adapted so that the reflectance thereof differs from those of other reflection regions, can be provided on the top surface 1a of the housing 1 of the reflection sheet 4, a side (hereunder referred to as “a back surface 4d”) of the reflection sheet 4, which side is at the side of the bottom surface 1d of the housing 1, is colored in this embodiment. Thus, the visibility of the color pattern from the opening 1d of the housing 1 becomes low, as compared with the case where a side (hereunder referred to as “a front surface 4e”) of the reflection sheet 4, which is located at the side of the top surface 1a of the housing 1, is colored. Consequently, the image quality is less subject to the influence of the printing irregularity of the color pattern. Therefore, it is preferable to color the back surface 4d.

Especially, in a case where the dot pattern 8 enabled to gradually change the reflectance is printed onto the front surface 4e of the reflection sheet 4 by coloring, change of the dot pattern can be easily and visually recognized. Thus, in this case, it is necessary to form dots of the dot pattern 8 to be small, as compared with the case of forming the dot pattern portion 8 on the back surface 4d of the reflection sheet 4. Consequently, in a case where the screen printing method is used, a screen may be clogged. Thus, the productivity may be lowered. However, in the case of providing the dot pattern portion 8 on the back surface 4d of the reflection sheet 4, the change of the dot pattern 8 is difficult to visually recognize. Thus, the dots of the dot pattern 8 can be formed to be relatively large. Therefore, the providing of the dot pattern portion 8 on the back surface 4 of the reflection sheet 4 can enhance productivity and is preferable.

Although the first reflection region 5a or the second reflection region 5b is formed in a part of the reflection sheet 4 in this first embodiment, reflection light reflected from the reflection sheet 4 is changed to blue by forming a reflection zone on the entire surface of the reflection sheet 4 so that a first reflectance at wavelengths of a first wavelength region (wavelengths ranging from 430 nm to 490 nm) corresponding to blue light included in the visible light outputted from the light source is higher than a second reflectance at wavelengths of a second wavelength region (wavelengths ranging from 640 nm to 770 nm) corresponding to red light included in the visible light and a third reflectance at wavelengths of a third wavelength region (wavelengths ranging from 490 nm to 550 nm) corresponding to green light included in the visible light, and so that the second reflectance and the third reflectance are equal to each other. This reflection zone is an effective countermeasure against the color irregularity.

In the foregoing description of the first embodiment, the surface light source device having one reflection sheet 4 has been described. A surface light source device having plural reflection sheets, in which the first reflection region 5a or the second reflection region 5b is formed in at least one of the plural reflection sheets 4, can obtain the aforementioned effects.

Especially, in a case where the first reflection region 5a or the second reflection region 5b printed onto the front surface 4e of the reflection sheet 4 by coloring, the color portion of the reflection sheet 4 is put into intimate contact with the light guide plate 7. Thus, wrinkles are apt to be generated due to the difference between the first reflection region 5a (or the second reflection region 5b) and each of the other regions in the degree of elongation caused by heat or water absorption.

Further, an air layer between the color portion of the reflection sheet 4 and the light guide plate 7 is eliminated. Light, which would be totally reflected by the bottom surface 7b serving as a boundary surface between the light guide plate 7 and the airlayer before printing the reflection sheet, reaches directly to the color portion. Then, the scattering or the reflection of the light is performed. Subsequently, the scattered or reflected light is outputted from the top surface 7a of the light guide plate 7 placed in the vicinity of the color portion of the reflection sheet 4. Consequently, color irregularity is caused.

In a case where a reflection zone is formed on the back surface 4d of the reflection sheet 4, the color portion of the reflection sheet 4 is put into intimate contact with the bottom surface 1b of the housing 1. Thus, wrinkles are liable to be generated due to the difference between the color portion and each of the other regions in the degree of elongation caused by heat or water absorption.

In contrast, preferably, a surface of the reflection sheet 4 (hereunder referred to as a first reflection sheet) having a reflection area, whose reflectance differs from that of the other regions of this surface, is disposed to be opposed to the other reflection sheet. Even when the reflection sheets are brought into intimate contact with each other, the reflection sheets are made of the same material. Thus, wrinkles are prevented from being generated in the first reflection sheet.

Incidentally, the reflection zone is the super ordinate concept of the first reflection region 5a and the second reflection region 5b and includes regions, each of which is adapted so that the reflectance at wavelengths of at least one of wavelength regions respectively corresponding to colors of visible light outputted from the light source differs from the reflectance at the wavelengths of the other wavelength regions of the visible light.

The reflection zone includes another super ordinate concept of the reflection region, that is, the reflection area, whose reflectance differs from that of the other regions of the surface. For example, in a case where each of the reflectance R at wavelengths of the wavelength region corresponding to red light, the reflectance G at wavelengths of the wavelength region corresponding to green light, and the reflectance B at wavelengths of the wavelength region corresponding to blue light is 90%, the reflection zone is a gray zone adapted so that the reflectance of the entire zone is reduced by setting the reflectances R, G, B at 50%. In this case, the formation of the reflection zone is an effective countermeasure against bright lines.

Among the plural reflection sheets, the reflectance of the reflection sheet at the side of the opening portion 1d of the housing 1 to be less than the reflectance of the reflection sheet at the side of the bottom surface 1b of the housing 1. Thus, an amount of light, which reaches the surface having the reflection area of the first reflection sheet by being transmitted by the reflection sheet at the side of the opening portion 1d of the housing 1, can be increased. Thus, luminance unevenness and color irregularity can be more effectively reduced. The efficiency of utilization of light can be enhanced by setting the reflectance of the reflection sheet, which is provided at the side of the bottom surface 1b of the housing 1, at a high value.

That is, among the plural reflection sheets, the reflectance of the reflection sheet provided at the side of the opening portion 1d of the housing 1 is adjusted thereby to adjust the amount of light, which reaches the surface having the reflection area of the first reflection sheet by being transmitted by the reflection sheet at the side of the opening portion 1d of the housing 1. Thus, the luminance unevenness and the color irregularity can be more effectively reduced.

The sheets can be put together by bonding the opposed surfaces of each pair of the plural reflection sheets through a bonding layer. This facilitates the assembly of the surface light source device. In this case, preferably, the refractive index of the bonding layer is set to be equal to that of the reflection sheets. Thus, refraction does not occur at the boundary between the reflection sheet and the bonding surface.

Although the first reflection region 5a or the second reflection region 5b is formed in the reflection sheet 4 in this first embodiment, instead, a color conversion sheet having a transmission region provided in a surface, which region differs from the other regions of the surface in transmissivity, is disposed at the side of the opening portion 1d of the housing 1 to face the reflection sheet. Thus, effects similar to those obtained by the coloring of the reflection sheet 4 can be obtained.

Incidentally, this color conversion sheet is a sheet that transmits light having only a specific wavelength. For example, this color conversion sheet is transparent thin-paper-like color cellophane.

The color conversion sheet has a first transmission region, which is provided at the side opposite to the light source and is adapted so that the transmissivity at shorter wavelengths of wavelength regions respectively corresponding to colors of visible light outputted from the light source is higher than the transmissivity at longer wavelengths of wavelength regions, and also has a second transmission region, which is provided at the light source side and is adapted so that the transmissivity at shorter wavelengths of wavelength regions respectively corresponding to colors of visible light is lower than the transmissivity at longer wavelengths of wavelength regions. Thus, effects similar to those obtained by the coloring of the reflection sheet 4 can be obtained.

A selective reflection sheet disposed at the side of the opening portion 1d of the housing 1 to face the reflection sheet 4 is added to the optical sheets. Thus, an amount of light, which reaches the reflection sheet 4, can be increased by reflecting a part of light, which is outputted from the opening portion 1d of the housing 1 and is incident on the selective reflection sheet, to the reflection sheet 4. Thus, an amount of light, which reaches the reflection sheet 4 can be increased. Consequently, luminance unevenness and color irregularity can be more effectively reduced.

Incidentally, this selective reflection sheet has luminance increase effects, and includes a prism sheet, which is shaped like a prism and returns light having been incident almost perpendicularly thereon to the reflection sheet 4 by performing total reflection thereon twice, and a reflection type polarizing sheet adapted to separate the incident light to reflection light and transmission light according to a polarizing direction.

As described above, the surface light source device according to the first embodiment of the invention can increase an amount of shorter wavelength light reflected in the first reflection region 5a, as compared with an amount of longer wavelength light, by coloring the first reflection region 5a in the reflection sheet 4 in blue or blue green. Thus, color irregularity, according to which the color of the display surface is changed to red so that the degree of change at the side opposite to the light source is more than the degree of change at the light source side, can be cancelled. The color irregularity at the opening portion 1d of the housing 1 can be suppressed.

An amount of longer wavelength light reflected in the second reflection region 5b can be increased, as compared with an amount of shorter wavelength light, by coloring the second reflection region 5b in the reflection sheet 4 in orange or red. Thus, blue color irregularity occurring at the light source side can be cancelled. The color irregularity at the opening portion 1d of the housing 1 can be suppressed.

### Second Embodiment

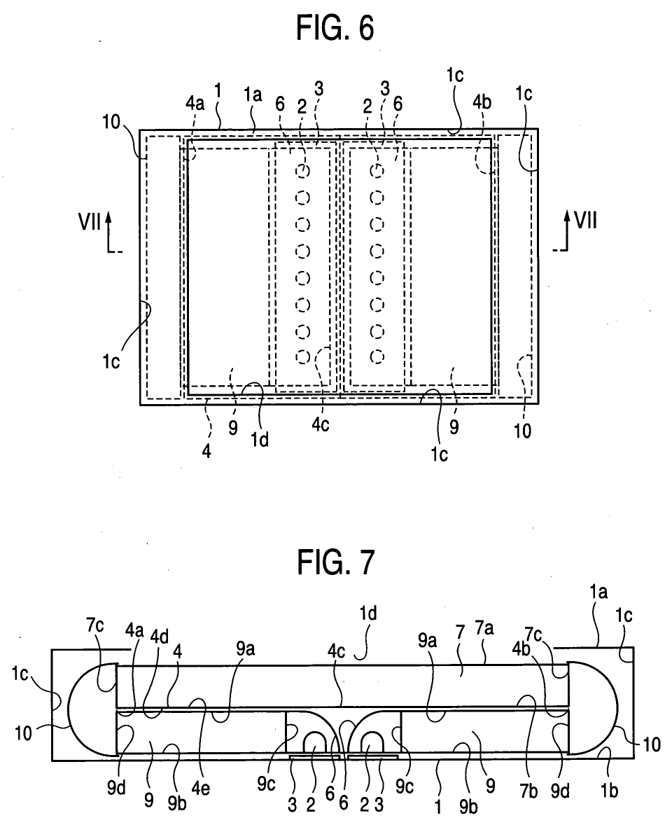

FIG. 6 is a plan view illustrating an outline of the configuration of a surface light source device according to a second embodiment of the invention. FIG. 7 is a partial cross-sectional view of the surface light source device, which is taken on line VII-VII shown in FIG. 6. Incidentally, in FIGS. 6 and 7, the same or corresponding components are designated by same reference characters as used to denote such components of the first embodiment. Thus, the description of such components is omitted herein.

Reference numeral 9 designates a color mixing light guide plate. Each of the color mixing light guide plates 9 has a pair of a top surface 9a and a bottom surface 9b, which are opposed to each other, and an incidence surface 9c and an output surface 9b, which are a pair of opposed side surfaces, among plural side surfaces defined by connecting edges of the top surface 9a and the bottom surface 9b. Preferably, all surface of the color mixing light guide plate 9 are mirror surfaces.

The lamp reflectors 6 are disposed around the point-like light sources 2 so as to collect light to an incidence surface 9c of the color mixing light guide plate 9 from the point-like light sources 2. The rectangular light guide plate 7 is placed so that the incidence surface 7c is disposed nearly in parallel to the output surface 9d of the color mixing light guide plate 9. The top surface 7a of the light guide plate 7 is used as an emission surface.

Mainly high transmissivity materials, such as PMMA (polymethylmethacrylate), PC (polycarbonate), or glass are used as the material of the color mixing light guide plate 9.

A reflection plate 10 is disposed to introduce light, which is outputted from the output surface 9d to the color mixing light guide plate 9, to the incidence surface 7c of the light guide plate 7. A cross-section of a reflection surface of the reflection 10, which is cut by a plane perpendicular to the top surface 7a and the incidence surface 7c of the light guide plate 7, is shaped like a semi-circle.

A reflection sheet 4 serving as light reflection means is disposed on the bottom surface 7b of the light guide plate 7. Incidentally, in a plane of the reflection sheet 4, which corresponds to the bottom surface 1b of the housing 1, a side located close to the light source is set to be a side at the light source side. Conversely, a side located far from the light source is set to be a side at the side opposite to the light source. In this second embodiment, the side of the incidence surface 7c of the light guide plate 7 is a side placed at the side of the reflection sheet 4.

Especially, in a case where two color mixing light guide plates 9 are provided in the device, and two incidence surfaces 7c of the light guide plate 7 are provided, as shown in FIGS. 6 and 7, the first side 4a and the second side 4b, which are located close to the light source, are at the light source side, while a central portion 4c located far from the light source and at an equal distance from the first side 4a and the second side 4b is at the side opposite to the light source as shown in FIG. 5B.

In a case where one color mixing light guide plate 9 is provided at the side of the incidence surface 7c of the light guide plate 7, and where only one incidence surface 7c of the light guide plate 7 is provided in the device, the first side 4a, which is located close to the as shown in FIG. 5A, is provided at the light source side, while the second side 4b opposed to the first side 4a is provided at the side opposite to the light source.

Next, an optical path, through which light emitted from the point-like light sources 2 is outputted from the opening portion 1d of the housing 1 after passing through the color mixing light guide plate 9 and the light guide plate 7, is described hereinbelow.

Monochromatic red, green, and blue light rays respectively emitted from the first point-like light source 2a, the second point-like light source 2b, and the third point-like light source 2c, which are the point-like light sources 2, are directly incident to the color mixing light guide plate 9 from the incidence surface 9c of the color mixing light guide plate 7 or is incident thereto after reflected by the lamp reflector 6.

The monochromatic light having been incident on the color mixing light guide plate 9 propagates therein while iteratively undergoing total reflection due to the difference in refractive index between the color mixing light guide plate 9 and the air. The monochromatic light spreads while propagating in the color mixing light guide plate 9. Thus, the monochromatic red, green, and blue light rays emitted from the point-like light sources 2 are mixed and uniformize into white light, which is then outputted from the output surface 9d of the color mixing light guide plate 9.

The light outputted from the output surface 9d of the color mixing light guide plate 9 is reflected by the reflection plate 10 and is incident on the incidence surface 7c of the light guide plate 7. The light having been incident on the light guide plate 7 propagates in the light guide plate 7 by iteratively undergoing total reflections due to the difference in refractive index between the light guide plate 7 and the air. A dot printing portion (not shown) is formed on the bottom surface 7b opposed to the top surface 7a. The light impinges on the dot printing portion and is diffusion-reflected, so that the light does not satisfy a total reflection condition. Thus, the light is outputted from the top surface 7a. Light outputted from the bottom surface 7b of the light guide plate 7 is reflected from the reflection sheet 4. The reflected light is then incident on the light guide plate 7 again. Thus, light is outputted from the opening portion 1d of the housing 1.

Incidentally, the second embodiment differs from the first embodiment only in that the second embodiment is implemented by adding the color mixing light guide plate 9 to the surface light source device according to the first embodiment. The second embodiment obtains advantages of the color mixing light guide plate 9, which will be described later, in addition to advantages similar to those of the first embodiment.

According to a liquid crystal display apparatus according to the first embodiment, monochromatic red, green, and blue light rays emitted from the point-like light sources 2 can be incident on the light guide plate as white light rays through the color mixing light guide plate 9. In addition, the light sources, which are the point-like light sources, are treated as a surface light source. Thus, the intensity of incident light on the incidence surface 7c of the light guide plate 4 is uniformized. Occurrences of the color irregularity and the luminance unevenness in the vicinity of the incidence surface 7c in the light guide plate 7 can be suppressed.

### Third Embodiment

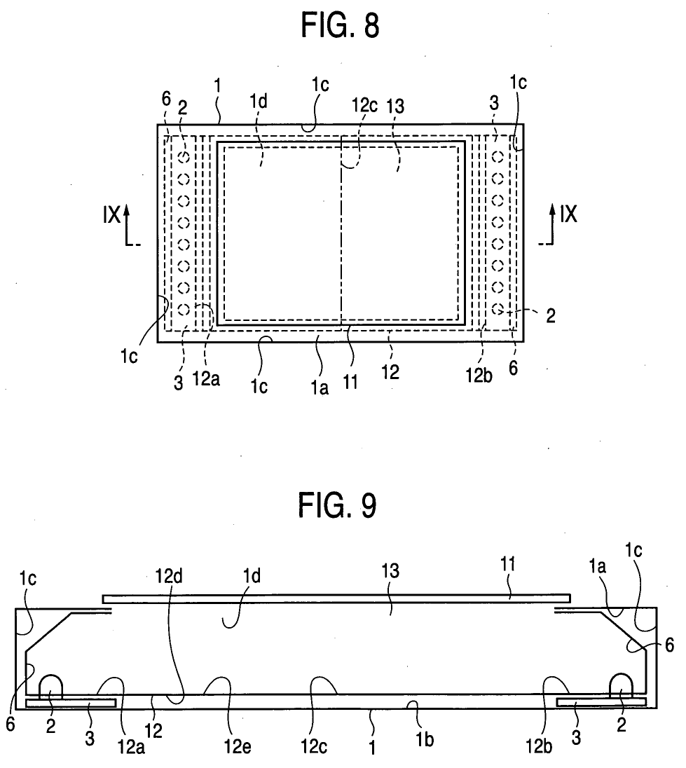

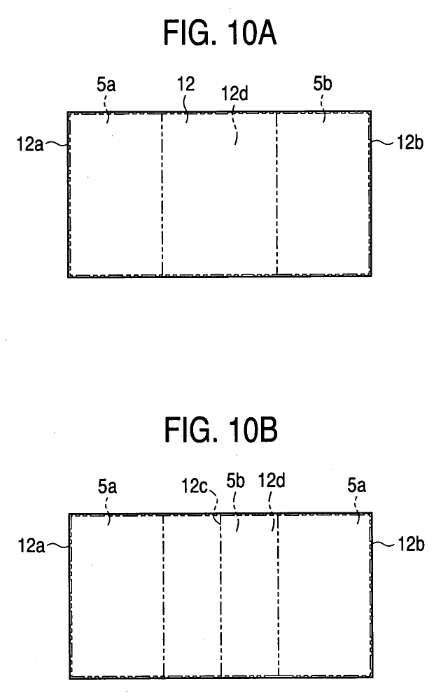

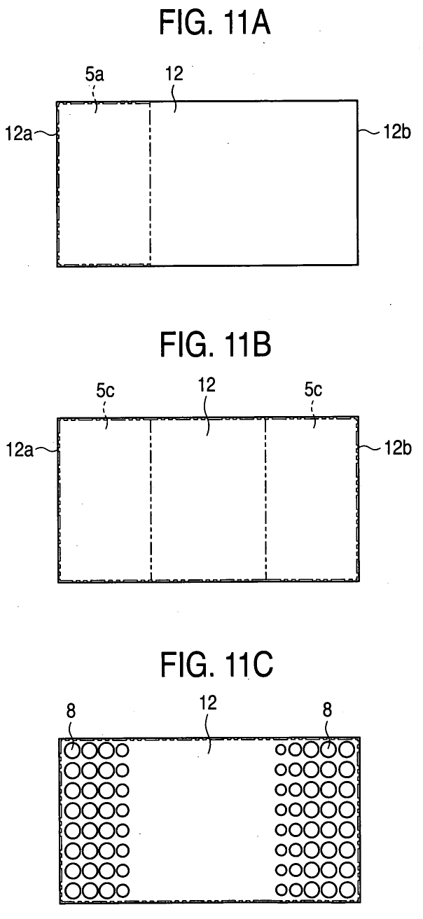

FIG. 8 is a plan view illustrating an outline of the configuration of a surface light source device according to a third embodiment of the invention. FIG. 9 is a partial cross-sectional view of the surface light source device, which is taken on line IX-IX shown in FIG. 8. FIGS. 10A and 10B are plan views illustrating color patterns of a reflection sheet. FIG. 10A is a plan view of a reflection sheet, which illustrates an example of the color pattern in a case where a light source is disposed only in the vicinity of one side surface of a housing and FIG. 10B is a plan view of the reflection sheet, which illustrates one example of the color pattern in a case where the light source is disposed in the vicinity of each of two opposed side surfaces of the housing. FIGS. 11A to 11C are plan views illustrating color patterns of a reflection sheet; FIG. 11A is a plan view of a reflection sheet, which shows another example of the color pattern in a case where a light source is disposed only in the vicinity of one side surface of a housing. FIG. 11B is a plan view of the reflection sheet, which shows another example of the color pattern in a case where the light source is disposed in the vicinity of each of two opposed side surfaces of the housing. FIG. 11C is a plan view of the reflection sheet, which shows still another example of the color pattern. In FIGS. 8 and 11C, the same or corresponding components are designated by same reference characters as used to denote such components in FIGS. 1 to 7. Thus, the description of such components is omitted herein.

A diffusion plate 11 is disposed, over the entire opening portion 1d of the housing 1. The diffusion plate 11 is formed of a resin plate, such as polyethylene terephthalate (PET), polymethylmethacrylate (PMMA) or polycarbonate (PC), alternatively, a glass substrate. Such a resin plate or a glass substrate has the function of transmitting light. Preferably, the diffusion plate 11 has the function of diffusing incident light. To this end, a refractive material is mixed into the diffusion plate 11. Alternatively, the surfaces of the diffusion plate 11 are roughened. Thus, a surface light source device having wide directivity can be obtained.

The housing 1 is constructed to prevent leakage of light therefrom as much as possible. Reflection sheets 12 are disposed on the inner bottom surface 1b of the housing 1 and on the inner side surfaces 1c thereof, in the vicinity of each of which a point-like light source substrate 3 is not disposed, so that light is reflected inside the housing 1 and travels toward the opening portion 1d. A hollow region 13 is formed between the reflection sheet 12 and the diffusion plate 11. Thus, light propagates in air provided in the hollow region 13.

The point-like light source substrate 3 is disposed along each of the two opposed surfaces 1c of the housing 1. Plural point-like light sources 2 are placed in row along each of the side surfaces 1c of the housing 1.

Each of the lamp reflectors 6 surrounds the point-like light sources 2 except a hollow-region-side part of the light sources 2, and reflects light outputted from the light sources to the hollow region 13.

Each of the reflection sheets 12 is constructed by replacing the position of the first reflection region 5a with the position of the second reflection region 5b in the reflection sheet 4. That is, the first reflection region 5a, of which the reflectance at shorter wavelengths is higher than that at longer wavelengths, is provided at the light source side. Further, the second reflection region 5b, of which the reflectance at shorter wavelengths is lower than that at longer wavelengths, is provided at the side opposite to the light source.

Incidentally, in a plane of the reflection sheet 12, which corresponds to the bottom surface 1b of the housing 1, a side located close to the light source is set to be a side at the light source side. Conversely, a side located far from the light source is set to be a side at the side opposite to the light source.

Especially, in a case where the light source is disposed only in the vicinity of the one side surface 1c of the housing 1, a first side 12a located close to the light source is at the light source side, while a second side 12b opposed to this first side 12a is at the side opposite to the light source, as shown in FIG. 10A.

In a case where the light source is disposed in the vicinity of each of the two opposed side surfaces 1c of the housing 1, the first side 12a and the second side 12b, which are located close to the light source, are at the light source side, while a central portion 12c located far from the light source and at an equal distance from the first side 12a and the second side 12b is at the side opposite to the light source, as shown in FIG. 10B.

In this third embodiment, the first reflection region 5a is a color pattern portion obtained by coloring the reflection sheet 12 in cyan, and is adapted so that the reflectance of light of wavelengths in wavelength regions respectively corresponding to red is 85% and that the reflectance of light of wavelengths in a wavelength region corresponding to blue and green is 90%.

The second reflection region 5b is a color pattern portion obtained by coloring the reflection sheet 12 in orange or red, and is adapted so that the reflectance of light of wavelengths in a wavelength region corresponding to blue is 80%, that the reflectance of light of wavelengths in a wavelength region corresponding to green is 85%, and that the reflectance of light of a wavelengths in wavelength region corresponding to red is 90%.

Next, an optical path, through which light emitted from the point-like light sources 2 is outputted from the diffusion plate 11, is described hereinbelow.

Monochromatic red, green, and blue light rays respectively emitted from the first point-like light source 2a, the second point-like light source 2b, and the third point-like light source 2c are directly led to the hollow region 13, or are led to the hollow region 13 after reflected by the lamp reflector 6.

In the hollow region 13, light emitted to the bottom surface 1b of the housing 1 is specularly reflected by a specular reflection material of the reflection sheet 12. Thus, light is propagated from the light source to the side opposite to the light source.

Light having been incident on the diffusion plate 11 is divided into components, one of which is transmitted by the diffusion light 11 and the other of which is reflected by particles contained in the diffusion plate 11. Between these components, the component reflected to the bottom surface 1b of the housing 1 is specularly reflected by the reflection sheet 12 and is incident on the diffusion plate 11 again. The component having been incident on and transmitted by the diffusion plate 11 are radiated in all directions.

The light outputted from the diffusion plate 11 passes through the optical sheets, which include the diffusion sheet, the protection sheet, and the lens sheet, and is incident on the light crystal display device. The liquid crystal display device is adapted so that the liquid crystal layer thereof is orientated in response to the on/off of a voltage applied thereto by a switching device (not shown). The light having been incident on the liquid crystal display device is modulated according to video signals. Thus, the liquid crystal display device shows a red, green, or blue color.

Incidentally, this third embodiment differs from the first embodiment only in that the light guide plate 7 is not disposed in the device, that the diffusion plate 11 is disposed over the entire of the opening portion 1d of the housing 1, and that the position of the first reflection region 5a is replaced with the position of the second reflection region 5b in the reflection sheet 4. The third embodiment has advantages due to the reflection sheet 12, which are described later, in addition to advantages similar to the first embodiment.

Because no light guide plate is used in this third embodiment, the weight and thickness of the surface light source device do not increase. Consequently, the surface light source device can be reduced in thickness and weight.

Because neither the light guide plate 7 nor the dot printing portion to be formed on the light guide plate 7 is provided in this third embodiment, shorter wavelength light is neither absorbed nor scattered.

Thus, the color irregularity, which is caused in the related surface light source device using the reflection sheet while light propagates in the light guide plate so that the red color irregularity does not occur on a part of the display surface extending from the light source side to the side opposite to the light source in the third embodiment. Thus, it is unnecessary to color the first reflection region 5a, which is provided in the vicinity of the second side 4b that is located at the side opposite to the light source of the reflection sheet 4, with a complementary color that cancels change in hue of light, which is outputted from the light source, at the opening portion 1d of the housing 1. Further, blue color irregularity does not occur at a light-source-side part of the opening portion 1d of the housing 1. Also, it is unnecessary to color the second reflection region 5b, which is provided in the vicinity of the first side 4a that is located at the light source side of the reflection sheet 4, with a complementary color that cancels change in hue of light, which is outputted from the light source, at the opening portion 1d of the housing 1.

Conversely, because the light guide plate 7 is not used, the luminance distribution reflects the luminosity distribution of the light source more accurately. When the luminosity distribution varies with the color of the emitted light as shown in FIGS. 4A and 4B, red color irregularity occurs at a p color source side part of the opening portion 1d of the housing 1, and cyan color irregularity occurs at a part of the opening portion 1d, which part is located at the side opposite to the color source, in the related surface light source device using the reflection sheet.

However, in this third embodiment, the second reflection region 5b of the reflection sheet 12, which region is provided on the central portion 12c that is at the side opposite to the light source, is colored with a complementary color that cancels change in hue of light, which is outputted from the light source, at the opening portion 1d of the housing 1. Thus, the color irregularity at the opening portion 1d of the housing 1 is suppressed.

Further, the first reflection region 5a of the reflection sheet 12, which region is provided in the vicinity of each of the first side 12a and the second side 12b at the light source side, is colored with a complementary color that cancels change in hue of light, which is outputted from the light source, at the opening portion 1d of the housing 1. Thus, the color irregularity at the opening portion 1d of the housing 1 is suppressed.

Incidentally, in a case where only one of the first reflection region 5a and the second reflection region 5b is formed on the reflection sheet 12, the effects of the formed reflection region can be obtained. Thus, the color irregularity can be more effectively suppressed, as compared with the related surface light source device. However, it is preferable that both the first reflection region 5a and the second reflection region 5b are formed on the reflection sheet 12, because the color irregularity can be suppressed over the part of the display surface extending from the light source side to the side opposite to the light source.

Meanwhile, in a case where the back surface 12d of the reflection sheet 12 is colored, the visibility of the color pattern from the opening 1d of the housing 1 becomes low as compared to the case where the surface 12e is colored. Thus, the image quality is less subject to the influence of the printing irregularity of the color pattern. Therefore, it is preferable to color the back surface 12d.

This third embodiment employs an LED emitting monochromatic red, green, or blue light as the point-like light source 2. However, in a case where a white LED emitting white light is employed, the third embodiment can cancel luminance irregularity by providing third reflection regions 5c, whose reflectance is lower than those of the other regions, in parts of the surface of the reflection sheet 12, which are respectively provided in the vicinities of the first side 12a and the second side 12b that are located close to the light sources as shown in FIG. 11B. Consequently, the third embodiment can suppress luminance irregularity occurring in the surface light source device.

This embodiment can solve the problem, which is caused in the related surface light source device that controls the luminance distribution of light outputted from the diffusion plate 11 and that cannot control light directly reaching the diffusion plate 11 from the point-like light source 2 without being reflected by the lamp reflector 6 or the reflection sheet 12, and which is a phenomenon that the luminance is high in the vicinity of the light source thereby to cause the luminance irregularity and to degrade the display quality.

The reflection region 5c, which differs in reflectance from other regions formed in the same surface of the reflection sheet 12, is formed in the vicinities of the first side 12a and the second side 12b, which are placed close to the light sources. The reflectance of the third reflection region 5c is set to be, for example, 85%, while that of the other regions is set to be 90%.

Alternatively, it is advisable to provide dot pattern 8, each of which is adapted to increase the occupation ratio thereof to a part of the reflection sheet 12 as the distance of this part from the point-like light source 2 increases, on the reflection sheet 12, as shown in FIG. 11C.

Incidentally, in a case where the light source is disposed only in the vicinity of the one side surface 1c of the housing 1, only the first side 12a located close to the light source is at the light source side, as shown in FIG. 1A. The luminance irregularity caused in the surface light source device can be suppressed by providing the third reflection region 5c, which is lower in reflectance than the other regions, in the vicinity of the first side 12a.

As described above, in the surface light source device according to the third embodiment, the reflection sheet has a reflection region, which -differs from other regions in the reflectance at wavelengths of at least a part of wavelength regions of visible light outputted from the light source. Thus, the third embodiment can cancel and suppress the luminance unevenness and the color irregularity, which occur according to the distance from the light source in the related surface light source device.

### FOURTH EXAMPLE

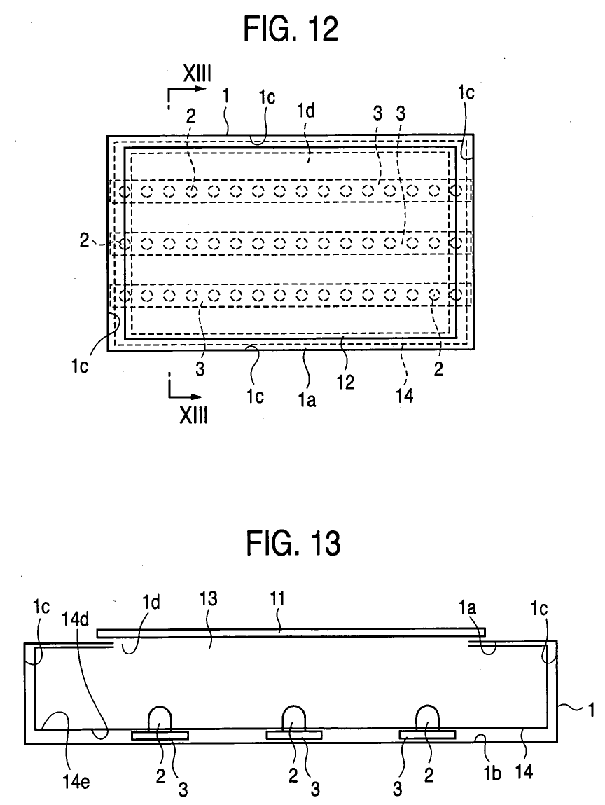

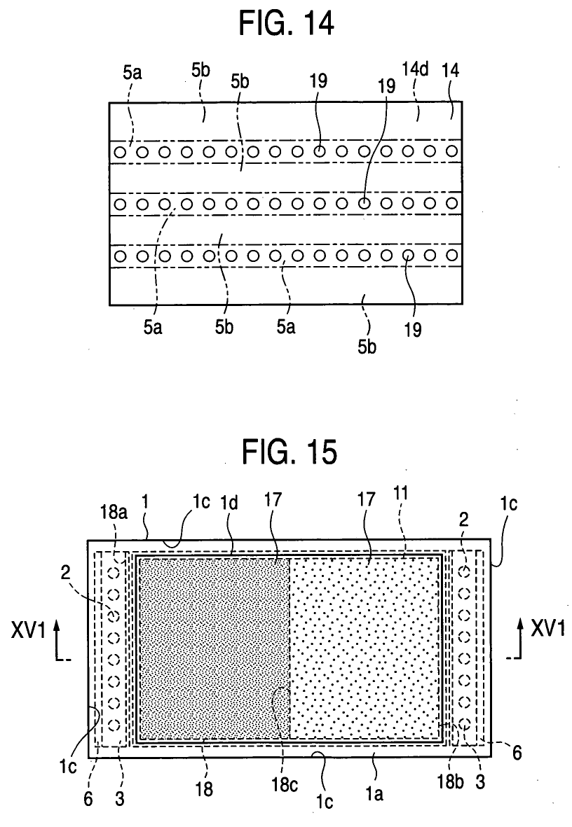

FIG. 12 is a plan view illustrating an outline of the configuration of a surface light source device according to a fourth embodiment of the invention. FIG. 13 is a partial cross-sectional view of the surface light source device, which is taken on line XIII-XIII shown in FIG. 12. FIG. 14 is a plan view of the reflection sheet, which shows an example of the color pattern. In FIGS. 12 to 14, the same or corresponding components are designated by same reference characters as used to denote such components in FIGS. 1 to 11C. Thus, the description of such components is omitted herein.

The housing 1 is constructed to prevent leakage of light therefrom as much as possible. Reflection sheets 14 are disposed on the inner bottom surface 1b of the housing 1 and on the inner side surfaces 1c thereof, in the vicinity of each of which a point-like light source substrate 3 is not disposed, so that light is reflected inside and travels toward the opening portion 1d. A hollow region 13 is formed between the reflection sheet 14 and the diffusion plate 11. Thus, light propagates in air provided in the hollow region 13.

The reflection sheet 14 differs from the aforementioned reflection sheet 12 only in the definitions of the “light source side” and the “side opposite to the light source”. Similarly to the reflection sheet 12, the reflection sheet 14 has the first reflection region 5a, which is provided at the light source side and is adapted so that the reflectance at shorter wavelengths of the wavelength regions is higher than the reflectance at longer wavelengths of the wavelength regions, and the second reflection region 5b, which is provided at the side opposite to the light source and is adapted so that the reflectance at shorter wavelengths of the wavelength regions is lower than the reflectance at longer wavelengths of the wavelength regions.

That is, in this fourth embodiment, as shown in FIGS. 13 and 14, in a plane of the reflection sheet 14, which plane corresponds to the bottom surface 1b of the housing 1, a side located in the vicinity of the light source is a light source side. Conversely, a side located far from this light source side, that is, each of the side between adjacent rows of the light sources 2 and the side of the side-surfaces 1c of the housing 1 is a side at the side opposite to the light source.

Holes 19, into each of which the point-like light source 2 is inserted, are provided in the reflection sheet 14.

Incidentally, in this fourth embodiment, the first reflection region 5a is a pattern portion obtained by coloring the reflection sheet 14 in blue or cyan so that, for example, the reflectance of light of wavelengths in a wavelength region corresponding to red is 75%, that the reflectance of light of wavelengths in a wavelength region corresponding to green is 87%, and that the reflectance of light of wavelengths in a wavelength region corresponding to blue is 90%.

The second reflection region 5b is a pattern portion obtained by coloring the reflection sheet 14 in red so that, for instance, the reflectance of light of wavelengths in a wavelength region corresponding to blue is 88%, that the reflectance of light of wavelengths in a wavelength region corresponding to green is 88%, and that the reflectance of light of a wavelengths in wavelength region corresponding to red is 90%.

Next, an optical path, through which light emitted from the point-like light sources 2 is outputted from the diffusion plate 11, is described hereinbelow.

Monochromatic red, green, and blue light rays respectively emitted from the first point-like light source 2a, the second point-like light source 2b, and the third point-like light source 2c are directly led to the diffusion plate 11, or are led to the diffusion plate 11 after reflected by the reflection sheet 14.

Light having been incident on the diffusion plate 11 is divided into components, one of which is transmitted by the diffusion light 11 and the other of which is reflected by particles contained in the diffusion sheet 11. Between these components of light, the component reflected to the light source side is specularly reflected, or is diffusion-reflected by the reflection sheet 14 or undergoes the combination of specular reflection and diffusion-reflection and is incident on the diffusion plate 11 again. The component having been incident on and transmitted by the diffusion plate are uniformly radiated in all directions.

Incidentally, this fourth embodiment differs from the first embodiment only in that the point-like light sources 2 are disposed just under the opening portion 1d of the housing 1, that the light guide plate 7 is not disposed in the device, that the diffusion plate 11 is disposed over the entire of the opening portion 1d of the housing 1, and that the positions of the first reflection region 5a and the second reflection region 5b in the reflection sheet 1 differ from those of the first reflection region 5a and the second reflection region 5b in the first embodiment. The third embodiment has advantages due to the reflection sheet 14, which are described later, in addition to advantages similar to the first embodiment.

This fourth embodiment can cancel luminance irregularity, which can be caused in the case of a related surface light source device of what is called the directly below type and is a phenomenon that the color of parts of the surface of the diffusion plate 11, on each of which the point-like light source 2 is present, is red and the color of parts provided therearound is blue, by coloring the reflection sheet 14 in the complementary color. Consequently, the fourth embodiment can suppress luminance irregularity at the opening portion 1d of the housing 1.

Incidentally, in a case where only one of the first reflection region 5a and the second reflection region 5b is formed on the reflection sheet 14, the effects of the formed reflection region can be obtained. Thus, the color irregularity can be more effectively suppressed, as compared with the related surface light source device. However, it is preferable that both the first reflection region 5a and the second reflection region 5b are formed on the reflection sheet 14, because the color irregularity can be suppressed over the part of the display surface extending from the light source side to the side opposite to the light source.

Further, in a case where the back surface 14d of the reflection sheet 14 is colored, the visibility of the color pattern from the opening 1d of the housing 1 is low, as compared with the case where the front surface 14e of the reflection sheet 14 is colored. Thus, the image quality is less subject to the influence of the printing irregularity of the color pattern. Consequently, it is preferable to color the back surface 14d.

### Fifth Embodiment

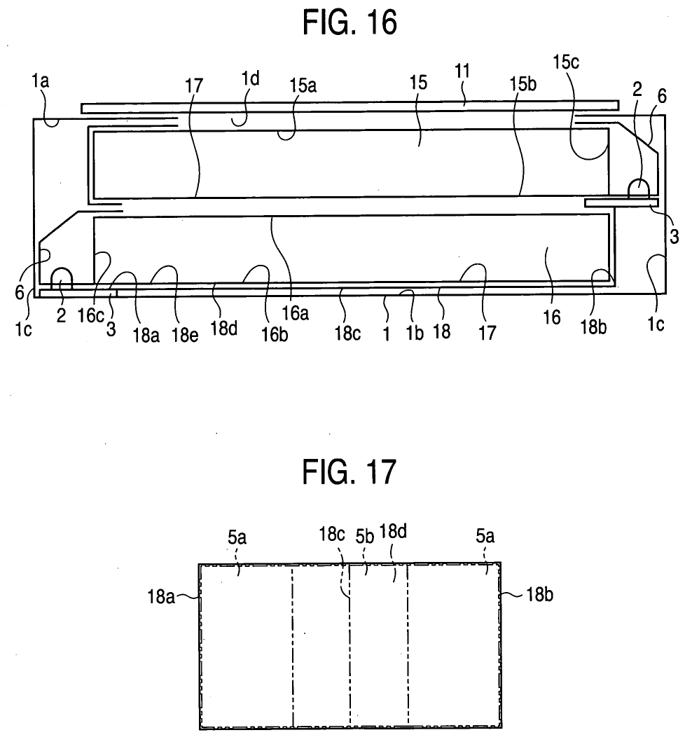

FIG. 15 is a plan view illustrating an outline of the configuration of a surface light source device according to a fifth embodiment of the invention. FIG. 16 is a partial cross-sectional view of the surface light source device, which is taken on line XVI-XVI shown in FIG. 15. FIG. 17 is a plan view of the reflection sheet, which shows an example of the color pattern. In FIGS. 15 to 17, the same or corresponding components are designated by same reference characters as used to denote such components in FIGS. 1 to 14. Thus, the description of such components is omitted herein.

This embodiment 5 has two light guide plates provided at upper and lower parts thereof, respectively. The light guide plate provided at the side of the opening portion 1d of the housing 1 is referred to as a first guide plate 15, while the light guide plate provided at the side of the bottom surface 1b of the housing 1 is referred to as a second guide plate 16.

Light output means 17 are formed on the bottom surface 15b of the first light guide plate 15 and on the bottom surface 16b of the light guide plate 16 to extend from the incidence surface 15c of the first light guide plate 15 and a surface opposed to the incidence surface 16c of the second light guide plate 16 to the substantially central portion, respectively.

Each of the light output means 17 is constituted by a dot pattern, which is obtained through a screen printing method, or by aw edge or a ridge, which is obtained by etching, scribing, or sand-blasting the bottom surface 15b or 16b. Alternatively, a member, on which a dot pattern, a wedge, or a ridge is formed, may be attached to the light output means.

The housing 1 is constructed to prevent leakage of light therefrom as much as possible. Reflection sheets 18 are disposed on the top inner surface la and the inner bottom surface 1b of the housing 1 and on the inner side surfaces 1c thereof, in the vicinity of each of which a point-like light source substrate 3 is not disposed, so that light is reflected inside and travels toward the opening portion 1d.

The reflection sheet 18 differs from the aforementioned reflection sheet 4 only in the positions of the light source side and the side opposite to the light source. Similarly to the reflection sheet 4, the reflection sheet 18 has the first reflection region 5a, which is provided at side opposite to the light source side and is adapted so that the reflectance at shorter wavelengths of the wavelength regions is higher than the reflectance at longer wavelengths of the longer wavelength regions.

That is, in this fifth embodiment, as shown in FIGS. 16 and 17, in a plane of the reflection sheet 18, which plane corresponds to the bottom surface 1b of the housing 1, a first side 18a located at the side opposed to the incidence surface 15c of the first light guide plate 15 is at the side opposite to the light source. Also, in a plane of the reflection sheet 18, which plane corresponds to the bottom surface 1b of the housing 1, a second side 18b located at the side opposed to the incidence surface 16c of the second light guide plate 16 is at the side opposite to the light source.

That is, the first side 18a and the second side 18b are at the side opposite to the light source, while a central portion 18c located far from the light source and at an equal distance from the first side 18a and the second side 18b is at a light source side.

Next, an optical path, through which light emitted from the point-like light sources 2 is incident on the diffusion plate 11, is described hereinbelow.

The light emitted from the point-like light source 2 adjoining the first light guide plate 15 is directly incident on an incidence face 15c of the first light guide plate 15 or is incident thereon after reflected by the lamp reflector 6.

The light emitted from the point-like light source 2 adjoining the second light guide plate 16 is directly incident on an incidence face 16c of the second light guide plate 16 or is incident thereon after reflected by the lamp reflector 6.

The light having been incident on the first light guide plate 15 is totally reflected iteratively at the boundary between the first light guide plate 15 and an air layer, while propagates in the first light guide plate 15. Incidentally, light, which has a traveling direction changed by the light output means 17 and thus does not meet the condition for total reflection, is outputted from the first light plate 15 and is incident on the diffusion plate 11 from the opening portion 1d of the housing 1. Incidentally, a part of light outputted from the first light guide plate 15 is reflected by the reflection sheet 18 disposed on each of the top surface 1a and the side surface 1c of the housing 1. Thus, the reflected light is incident on the first light guide plate 15 again. Then, the incident light propagates in the first light guide plate 15, far from the light source. Further, light outputted from the bottom surface 15b of the first light guide plate 15 reaches the reflection sheet 18 through the second light guide plate 16 and is then reflected and is returned to the first light guide plate 15 through the second light guide plate 16.

Similarly, the light having been incident on the second light guide plate 16 is totally reflected iteratively at the boundary between the second light guide plate 16 and an air layer, while propagates in the second light guide plate 16. Incidentally, light, which has a traveling direction changed by the light output means 17 and thus does not meet the condition for total reflection, is outputted from the second light plate 16 and is incident on the diffusion plate 11 from the opening portion 1d of the housing 1 through the first light guide plate 15. Incidentally, a part of light outputted from the second light guide plate 16 is reflected by the reflection sheet 18 disposed on each of the bottom surface 1b and the side surface 1c of the housing 1. Thus, the reflected light is incident on the second light guide plate 16 again. Then, the incident light propagates in the second light guide plate 16, far from the light source. Incidentally, light outputted from the top surface 16a of the second light guide plate 16 is incident on the first light guide plate 15 from the bottom surface 15b and then propagates in the first light guide plate 15.

The light propagating in the light guide plate 15 is diffusion-reflected at the light output means 17 formed on the bottom surface 15b of the first light guide plate 15, which corresponds to the opening portion 1d of the housing 1, to thereby change the propagating direction of the light. Thus, the light can be incident on the top surface 15a of the light guide plate 15 at an incidence angle, which is less than a critical angle, with respect to the boundary between the first light guide plate 15 and the air layer. Finally, the light is outputted from the opening portion 1d of the housing 1, which portion does not have the reflection sheet 18, and is then incident on the diffusion plate 11.

Incidentally, the light guide plate and the reflection sheet are liable to absorb or scatter shorter wavelength light. Thus, in the related surface light source device using the reflection sheet, during light propagates in the light guide plate 7, the color of each of parts of the first light guide plate 15 and the second light guide plate 16, which are at the side opposite to the light source, changes to red. At the opening portion 1d of the housing 1, red color irregularity may occur at both end portions of the opening portion 1d of the housing 1, which are at the side opposite to the light source.

However, in this fifth embodiment, the first reflection region 5a of the reflection sheet 18, which region is provided in the vicinity of each of the first side 18a and the second side 18b that are at the side opposite to the light source, is colored in a complementary color that cancels change in hue of light, which is outputted from the light source, at the opening portion 1d of the housing 1. Thus, the color irregularity at the opening portion 1d of the housing 1 is suppressed.

Incidentally, this fifth embodiment differs from the first embodiment only in that the positions of the first reflection region 5a and the second reflection region 5b of the reflection sheet 18 are obtained by replacing the position of the first reflection region 5a with the position of the second reflection region 5b of the reflection sheet 4. The fifth embodiment obtains advantages of the reflection sheet 18, which will be described later, in addition to advantages similar to those of the first embodiment.

This fifth embodiment can cancel color irregularity and suppress color irregularity, which could be caused in the related surface light source device, at the opening portion 1d of the housing 1 by coloring the reflection sheet 18 in the complementary color.

Incidentally, in a case where only one of the first reflection region 5a and the second reflection region 5b is formed on the reflection sheet 18, the effects of the formed reflection region can be obtained. Thus, the color irregularity can be more effectively suppressed, as compared with the related surface light source device. However, it is preferable that both the first reflection region 5a and the second reflection region 5b are formed on the reflection sheet 18, because the color irregularity can be suppressed over the part of the display surface extending from the light source side to the side opposite to the light source.

Incidentally, in a case where the back surface 18d of the reflection sheet 18 is colored, the visibility of the color pattern from the opening 1d of the housing 1 is low, as compared with the case where the front surface 18e of the reflection sheet 18 is colored. Thus, the image quality is less subject to the influence of the printing irregularity of the color pattern. Consequently, it is preferable to color the back surface 18d.

### Sixth Embodiment

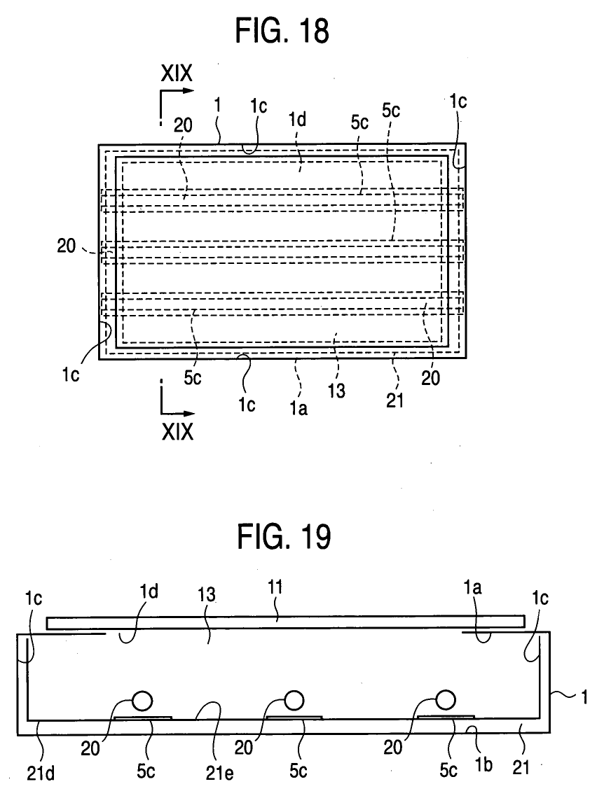

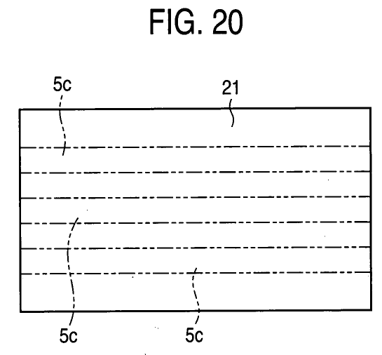

FIG. 18 is a plan view illustrating an outline of the configuration of a surface light source device according to a sixth embodiment of the invention. FIG. 19 is a partial cross-sectional view of the surface light source device, which is taken on line XIX-XIX shown in FIG. 18. FIG. 20 is a plan view of a reflection sheet, which shows an example of a coloring pattern. In FIGS. 18 to 20, the same or corresponding components are designated by same reference characters as used to denote such components in FIGS. 1 to 17. Thus, the description of such components is omitted herein.

This sixth embodiment uses cold cathode fluorescent lamps (CCFL), which are linear light sources 20 and disposed in parts of a hollow region 13, which are placed in the vicinity of the bottom surface 1b of the housing 1.

The housing 1 is constructed to prevent leakage of light therefrom as much as possible. Reflection sheets 21 are disposed on the inner bottom surface 1b of the housing 1 and on the inner side surfaces 1c thereof, so that light is reflected inside and travels toward the opening portion 1d. A hollow region 13 is formed between the reflection sheet 21 and the diffusion plate 11. Thus, light propagates in air provided in the hollow region 13.

The reflection sheet 21 is provided with a third reflection region 5c, which differs in reflectance from other regions, is formed in the vicinities of parts respectively provided just below the linear light sources 20. In this third embodiment, the reflectance of the third reflection region 5c is set to be, for example, 70%, while that of the other regions is set to be 90%.

Next, an optical path, through which light emitted from the linear light sources 20 is outputted from the diffusion plate 11, is described hereinbelow.

Light outputted from the linear light sources 20 is directly led to the diffusion plate 11, or is led thereto after reflected by the reflection sheet 21.

Light having been incident on the diffusion plate 11 is divided into components, one of which is transmitted by the diffusion light 11 and the other of which is reflected by particles contained in the diffusion plate 11. Between these components, the component reflected to the bottom surface 1b of the housing 1 is specularly reflected by the reflection sheet 21 and is incident on the diffusion plate 11 again. The component having been incident on and transmitted by the diffusion plate are radiated in all directions.

Incidentally, this sixth embodiment differs from the third embodiment only in that the linear light sources 20 are used as the light sources and are disposed just below the opening portion 1d of the housing 1, and that the position of the third reflection region 5c on the reflection sheet 21 differs from the position of the third reflection region 5c on the reflection sheet 12. The sixth embodiment has advantages due to the reflection sheet 21, which are described later, in addition to advantages similar to the first embodiment.

This sixth embodiment can cancel luminance irregularity, which can be caused in the case of a related surface light source device of what is called the directly below type using a linear light source and is a phenomenon that parts of the surface of the diffusion plate 11, which are placed just above the linear light sources 20, are bright portions, by providing a low-reflectance third reflection region 5c in a part of the surface of the reflection sheet 21, which part is provided directly beneath and in the vicinity of the linear light source 20. Consequently, the sixth embodiment can suppress luminance irregularity at the opening portion 1d of the housing 1.

Incidentally, in a case where the back surface 21d of the reflection sheet 21 is colored, the visibility of the color pattern from the opening 1d of the housing 1 is low, as compared with the case where the front surface 21e of the reflection sheet 21 is colored. Thus, the image quality is less subject to the influence of the printing irregularity of the color pattern. Consequently, it is preferable to color the back surface 21d.

What is claimed is:

1. A surface light source device comprising:
a housing having an opening portion provided in a top surface thereof;
a reflection sheet disposed on a bottom surface of the housing;
a light guide plate disposed on the reflection sheet on a side of the opening; and
a light source disposed on at least one of side surfaces of the housing,
wherein the reflection sheet has a first reflection region on a side opposite to the light source, and
a reflectance of the first reflection region at shorter wavelengths in a wavelength region of visible light outputted from the light source is higher than a reflectance at longer wavelengths in the wavelength region of the visible light.

2. A surface light source device comprising:
a housing having an opening portion provided in a top surface thereof;
a reflection sheet disposed on a bottom surface of the housing;
a light guide plate disposed on the reflection sheet on a side of the opening; and
a light source disposed on at least one of side surfaces of the housing,
wherein the reflection sheet has a second reflection region on a side of the light source, and
a reflectance of the second reflection region at shorter wavelengths in a wavelength region of visible light outputted from the light source is lower than a reflectance at longer wavelengths in the wavelength region of the visible light.

3. A surface light source device comprising:
a housing having an opening portion provided in a top surface thereof;
a light guide plate disposed in the housing corresponding to the opening portion;
a reflection sheet disposed on a bottom surface of the housing;
a color mixing light guide plate disposed between the reflection sheet and the bottom surface of the housing; and
a light source disposed on an incidence face of the color mixing light guide plate,
wherein the reflection sheet has a reflection region, and
a reflectance of the reflection region of at least a part of wavelength in a wavelength region corresponding to a wavelength region of visible light outputted from the light source differs from a reflectance of other wavelength in the wavelength region.

4. A surface light source device comprising:
a housing having an opening portion;
a diffusion plate disposed along the opening portion;
a reflection sheet disposed in the housing to form a hollow region between the diffusion plate and the reflection sheet; and
a light source disposed in the housing,
wherein the reflection sheet has a reflection region, and
a reflectance of the reflection region of at least a part of wavelength in a wavelength region corresponding to a wavelength region of visible light outputted from the light source differs from a reflectance of other wavelength in the wavelength region.

5. A surface light source device comprising:
a housing having an opening portion provided-in a top surface thereof;
at least one reflection sheet disposed on a bottom surface of the housing; and
a light source disposed in the housing,
wherein the surface light source device has a plurality of reflection sheets;
at least one of the reflection sheets is a first reflection sheet having a reflection region adapted to vary a reflectance in a surface thereof, and
the surface of the first reflection sheet, in which the reflection region is provided, faces other reflection sheets.

6. The surface light source device according to claim 5,
wherein the first reflection sheet has a reflection region, and
a reflectance of the reflection region of at least a part of wavelength of a wavelength region respectively corresponding to a color of visible light outputted from the light source differs from a reflectance at a wavelength of the other wavelength region.

7. The surface light source device according to claim 6,
wherein the first reflection sheet has a first reflection region on a side opposite to the light source, and
a reflectance of the first reflection region at shorter wavelengths in a wavelength region of visible light outputted from the light source is higher than a reflectance at longer wavelengths in the wavelength region of the visible light.

8. The surface light source device according to claim 5,
wherein among the plurality of reflection sheets, a reflection sheet disposed on a side of the opening of the housing has reflectance lower than a reflectance of a reflection sheet disposed on a side of the bottom surface of the housing.

9. The surface light source device according to claim 1,
wherein a difference between the reflectance at the longer wavelengths and the reflectance at the shorter wavelengths of the reflection sheet increases as a distance of the reflection sheet from the light source increases.

10. The surface light source device according to claim 2,
wherein a difference between the reflectance at the longer wavelengths and the reflectance at the shorter wavelengths of the reflection sheet decreases as a distance of the reflection sheet from the light source increases.

11. The surface light source device according to claim 1,
wherein the reflection sheet is colored to obtain a desired value of reflectance.

12. The surface light source device according to claim 11,
wherein the reflection sheet is colored with a complementary color that cancels change in hue of light, which is outputted from the light source, at the opening portion.

13. The surface light source device according to claim 11,
wherein a surface of the reflection sheet on a side of the bottom surface of the housing is colored.

14. A surface light source device comprising:
a housing having an opening portion provided in a top surface thereof;
a reflection sheet disposed on a bottom surface of the housing;
a color conversion sheet disposed on the reflection sheet on a side of the opening; and
a light source disposed in the housing,
wherein the color conversion sheet has a transmission region adapted to vary a transmissivity in a surface thereof.

15. The surface light source device according to claim 14,
wherein the color conversion sheet has a transmission region, and
a transmissivity of the transmission region at wavelength of at least one of wavelength regions respectively corresponding to colors of visible light outputted from the light source differs from a transmissivity at wavelength of other wavelength region.

16. The surface light source device according to claim 15, further comprising:
a light guide plate disposed on a part of the reflection sheet on a side of the opening,
wherein the light source is disposed on at least one of side surfaces of the housing,
the color conversion sheet has a first transmission region on a side opposite to the light source, and
a transmissivity of the first transmission region at shorter wavelengths of a wavelength region of visible light outputted from the light source is higher than a transmissivity at longer wavelengths of the wavelength region of the visible light.

17. The surface light source device according to claim 1,
wherein a selective reflecting sheet disposed on the reflection sheet on a side of the opening.

18. The surface light source device according to claim 1,
wherein the light source is a linear light source.

19. The surface light source device according to claim 1,
wherein the light source is a light emitting diode that emits red, green, or blue monochromatic light.

20. A display apparatus comprising:
a surface light source device; and
a display portion disposed on an upper part of the surface light source device,
wherein the surface light source device includes:
a housing having an opening portion provided in a top surface thereof;
a reflection sheet disposed on a bottom surface of the housing;
a light guide plate disposed on the reflection sheet on a side of the opening; and
a light source disposed on at least one of side surfaces of the housing,
the reflection sheet has a first reflection region on a side opposite to the light source, and
a reflectance of the first reflection region at shorter wavelengths in a wavelength region of visible light outputted from the light source is higher than a reflectance at longer wavelengths in the wavelength region of the visible light.
